(19) United States
(12) Patent Application Publication
(10) Pub. No.: US 2007/0033361 A1
(43) Pub. Date: Feb. 8, 2007

(54) Apparatus, system, and method for fastcopy target creation

(76) Inventors: Jasmeer Kuppavilakom Abdulvahid, Santa Clara, CA (US); Clement Lambert Dickey, San Jose, CA (US); Lu Nguyen, Silver Spring, MD (US); Willie Lee Scott, Austin, TX (US); Pankaj Tandon, Sunnyvale, CA (US)

Correspondence Address: KUNZLER & ASSOCIATES, 8 EAST BROADWAY, SUITE 600, SALT LAKE CITY, UT, 84111, US

(21) Appl. No.: 11/195,072

(22) Filed: Aug. 2, 2005

(51) Int. Cl. G06F 13/00; G06F 12/00

(52) U.S. Cl. 711/165; 711/170

(57) ABSTRACT

An apparatus, system, and method are disclosed for autonomically creating a target volume in conjunction with a fastcopy data operation. The apparatus includes a selection module, a creation module, and a write module. The selection module selects a source volume from a source pool. The creation module creates a target volume from a predefined target storage space. The target volume corresponds to the source volume. The write module writes fastcopy data from the source volume to the target volume. The apparatus, system, and method minimize user intervention and facilitate on-demand creation of target volumes from the target storage space.

### BACKGROUND

1. Field of Art

This invention relates to data copy technology and more particularly relates to autonomic creation of a target volume for a fastcopy operation.

2. Background Technology

In a data processing system, a backup/restore subsystem is typically used to save a recent copy or version of one or more data sets, or a portion thereof, on some form of backup data storage device. Such backup copies are typically stored using magnetic or optical disk drives, tape drives, or other memory. The backup/restore subsystem is used to protect against loss of data. For example, if an online version of one or more data sets is destroyed, corrupted, deleted, or changed because of a failure event, the latest version of those data sets which are stored in a backup/restore subsystem can be restored. In this way, the risk of loss of data is minimized. Typical failure events include power failure, hardware error, software error, user error, or some other type of problem.

As but one example, a log-structured array subsystem (LSA) implements “virtual volumes”, wherein each virtual volume is created using a “virtual track table” having pointers to “virtual tracks” (i.e., records). The virtual tracks are in a sequential byte stream and updated tracks are written to a new location at the logical end of the byte stream. Accordingly, the associated pointers for the updated data are reset to the new locations. Thereafter, the tracks at the old location in the sequential byte stream are no longer needed and can be released as free space for reclamation and reuse. The storage can take place in standard direct access storage device (DASD) with sequentially numbered tracks by the use of an emulation system.

Currently available LSA subsystems generally support an instant copy function that can be referred to herein as FlashCopy®. The instant copy function operates by copying pointers between virtual track tables representing different virtual data volumes, without actually moving any data.

Currently, a system administrator is highly involved in the fastcopy process of creating a point-in-time backup. For example, a system administrator may perform the following steps:
1. Select one or more source disks to be backed up using a fastcopy operation;
2. Record the exact size of each source volume;
3. Create a target volume of the same size for each source volume;
4. Notify other administrators and/or software applications that the target volumes are in use;
5. Create a fastcopy relationship between each source volume and the corresponding target volume;
6. Add all of the fastcopy relationships to a fastcopy consistency group; and
7. Prepare and invoke the fastcopy consistency group.

Similarly, once a target volume is no longer being used as a valid backup of the corresponding source volume (e.g. a more recent backup copy exists), the administrator manually performs the following steps:
1. Delete the fastcopy consistency group and fastcopy relationships; and
2. Notify other administrators and/or software applications that the target volumes are not longer being used.

Involvement of a system administrator in the current fastcopy process poses several disadvantages. First, the conventional fastcopy operations are subject to user error. For example, a user might accidentally select and overwrite a target volume that contains useful and valid data. Second, an administrator pre-creates and selects the target volumes for each fastcopy operation performed. This poses a relatively high overhead cost for execution of fastcopy operations. Third, the target volumes, once created, cannot be used for any other purpose. The target volumes cannot even be used by other hosts or for source disks that are of a different size than the target volume. Fourth, conventional fastcopy operations require substantial coordination among system administrators and with regard to other fastcopy operations. If such coordination is not properly performed, the fastcopy data is at risk of being lost or corrupted. These are just a few of the disadvantages posed by conventional fastcopy technologies.

From the foregoing discussion, it should be apparent that a need exists for an apparatus, system, and method that overcome the limitations of conventional fastcopy technologies. In particular, such an apparatus, system, and method would beneficially minimize administrator intervention and expand the flexibility of target volume creation.

### SUMMARY

The several embodiments of the present invention have been developed in response to the present state of the art, and in particular, in response to the problems and needs in the art that have not yet been fully solved by currently available fastcopy technologies. Accordingly, the present invention has been developed to provide an apparatus, system, and method for autonomic creation of a target volume that overcome many or all of the above-discussed shortcomings in the art. In particular, embodiments of the invention facilitate on-demand creation of a target volume from a predefined target storage space.

The apparatus to autonomically create a target volume is provided with a logic unit containing a plurality of modules configured to functionally execute the necessary operations for target volume creation. These modules in the described embodiments include a creation module, a selection module, and a write module. Further embodiments include a designation module, a configuration module, a group module, a relationship module, and a reclamation module.

In one embodiment, the selection module selects a source volume from a source pool. The source pool includes one or more source volumes selected for a fastcopy operation. A particular source volume may be included in the source pool in response to a user selection at the host, for example, or based on a designation of the source volume by a backup application (not shown) or other computer program.

In one embodiment, the creation module creates a target volume from a predefined target storage space without intervention by a user. Additionally, the creation module may create a target volume that is identical in size to a corresponding source volume. In other embodiments, the creation module also generates a source sum that is descriptive of the total size of a source pool. After generating a source sum, the creation module may determine if the source sum is greater than the total size of the target storage space. In one embodiment, the write module writes the fastcopy data from the source volume to the target volume.

In one embodiment, the designation module designates the target storage space to be used for creation of the target volumes. By having a designated target storage space, the chance of accidentally overwriting important production data or other fastcopy target volumes diminished or eliminated. Additionally, the availability of the designated target storage space allows multiple users to access the target storage space when creating a new target volume. In this way, the amount of designated target storage space may be minimized or optimized according to the number of users or the user requirements. Minimization or optimization of the size of the designated target storage space minimizes the amount of wasted space on the storage controller.

In one embodiment, the configuration module defines one or more configuration parameters. Furthermore, the configuration module may configure the target storage space according to one or more configuration parameters. Some exemplary configuration parameters may include, but are not limited to, a media type parameter, a drive type parameter, a performance parameter, or a cost parameter.

In one embodiment, the group module creates a fastcopy consistency group. The fastcopy consistency may group include one or more source volumes and a corresponding number of target volumes. The use of a consistency group provides a high-fidelity backup by copying all of the volumes in the consistency group at exactly the same point in time.

In one embodiment, the relationship module creates a fastcopy relationship between a source volume and a corresponding target volume. The fastcopy relationship may be used to identify which source volumes and target volumes may be included in a fastcopy consistency group.

In one embodiment, the reclamation module returns a target volume to the target storage space after the target volume has been deleted or is otherwise no longer used by the storage controller. In other words, the reclamation module may return the capacity of the target volume to the target storage space. In this way, the size of the target storage space may be maintained by reusing space that previously belonged to the target storage space.

A service method related to autonomically create a target volume is also presented. The service method includes deploying computing infrastructure that includes computer readable code in a computing system. In one embodiment, the code in combination with the computing system is capable of selecting a source volume from a source pool, creating a target volume from a predefined target storage space, the target volume corresponding to the source volume, and writing fastcopy data from the source volume to the target volume.

In another embodiment, the code in combination with the computing system is further capable of designating the predefined target storage space in accordance with a configuration parameter. In another embodiment, the code in combination with the computing system is further capable of returning the target volume to the target storage space in response to a deletion of the target volume.

A signal bearing medium is also presented to store a program that, when executed, performs operations to autonomically create a target volume. In one embodiment, the operations include selecting the source volume from a source pool, creating a target volume from a predefined target storage space, the target volume corresponding to the source volume, and writing fastcopy data from the source volume to the target volume.

In another embodiment, the operations may include designating the predefined target storage space and/or defining a configuration parameter for the target storage space. In another embodiment, the operations may include creating a fastcopy consistency group including the target volume and the source volume and/or creating a fastcopy relationship between the target volume and the source volume. In another embodiment, the operations may include generating a source sum descriptive of a total size of a source pool, including the source volume, and determining if the source sum is greater than a total size of the predefined target storage space. In another embodiment, the operations may include returning the target volume to the target storage space in response to a deletion of the target volume.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a data storage system;

FIG. 2 is a schematic block diagram illustrating one embodiment of a fastcopy apparatus;

FIG. 3 is a schematic flow chart diagram illustrating one embodiment of a target creation method;

FIG. 4 is a schematic flow chart diagram illustrating one embodiment of a fastcopy method;

FIG. 5 is a schematic flow chart diagram illustrating one embodiment of a consistency group method; and

FIG. 6 is a schematic flow chart diagram illustrating one embodiment of a reclamation method.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

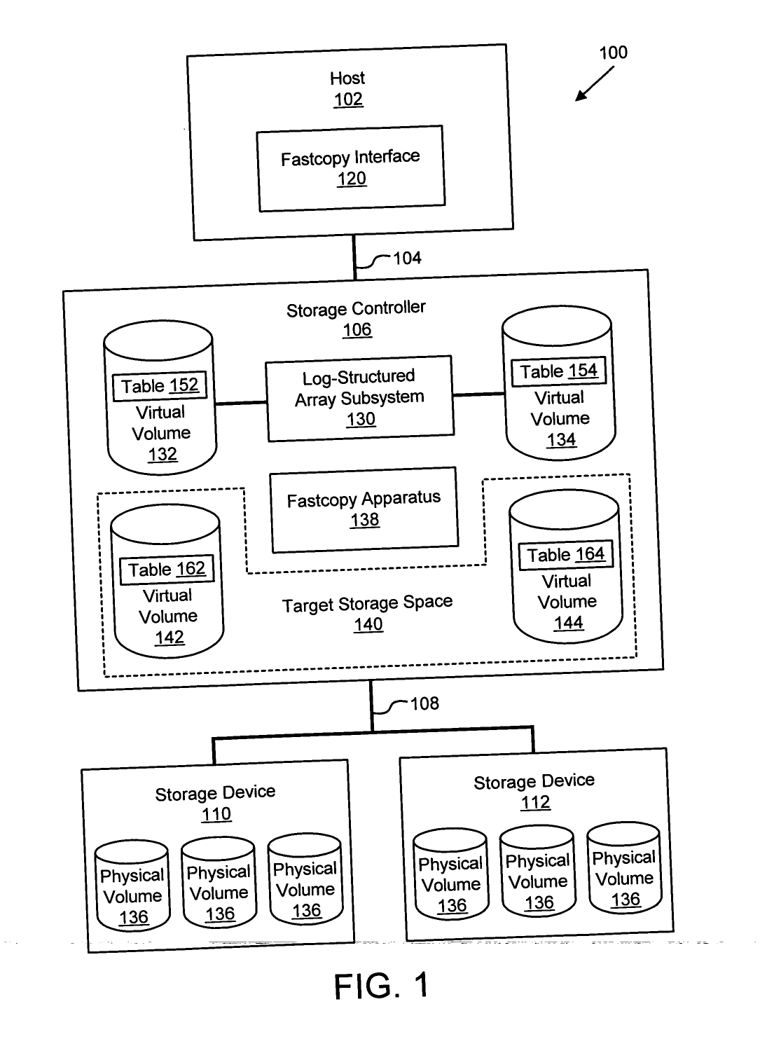

FIG. 1 depicts one embodiment of a data storage system 100. The illustrated data storage system 100 is an exemplary and non-limiting hardware environment. A host computer 102 is coupled via a communication channel or bus 104 to a storage controller 106. The storage controller 106 is coupled via an I/O channel 108 to one or more data storage devices 110, 112. Although one host computer 102 is shown, in practice a plurality of host computers 102 may share one or more data storage devices 110, 112 via the storage controller 106. In an exemplary, and non-limiting, embodiment the data storage devices 110, 112 may each comprise RAID (redundant arrays of inexpensive disks) storage subsystems. Alternatively, other types of data storage devices 110, 112 may be used within the data storage system 100.

In one embodiment, the host computer 102 executes one or more computer programs that control the operation of the host computer 102 and its interaction with the storage controller 106. One example of such a program is a fastcopy application (not shown). In one embodiment, the fastcopy application may communicate with the storage controller 106 via a fastcopy interface 120. Alternatively, the fastcopy application may reside in the storage subsystem, such as on the storage controller 106. However, other computer programs may be used as well. In one embodiment, the fastcopy application facilitates a fastcopy data operation in which data is copied from a source volume to a target volume using an instant copy technology. One example of an instant copy technology is FlashCopy® by International Business Machines, Inc. of Armonk, N.Y.

Similarly, the storage controller 106 may include one or more computer programs or other logic that control the operation of the storage controller 106 and its interaction with the host computer 102. These programs or logic also control the interaction of the storage controller 106 with the data storage devices 110, 112. In one embodiment, these programs or logic may implement a log-structured array (LSA) subsystem 130 that provides the access logic for the data storage devices 110, 112. In another embodiment, these programs may facilitate other operation or interaction functions, as well.

In one embodiment, The LSA subsystem 130 constructs “virtual volumes” 132, 134 in the memory (not shown) of the storage controller 106 for access by the host computer 102. The host computer 102 (or any computer program executed by the host 102) views the virtual volumes 132, 134 of the LSA subsystem 130 as normal data volumes. For example, the host 102 may view the virtual volume 132 as a standard DASD, with sequentially numbered tracks, even though the virtual volume 132 is only a logical representation of some of the data within the physical volumes 136 of the data storage devices 110, 112.

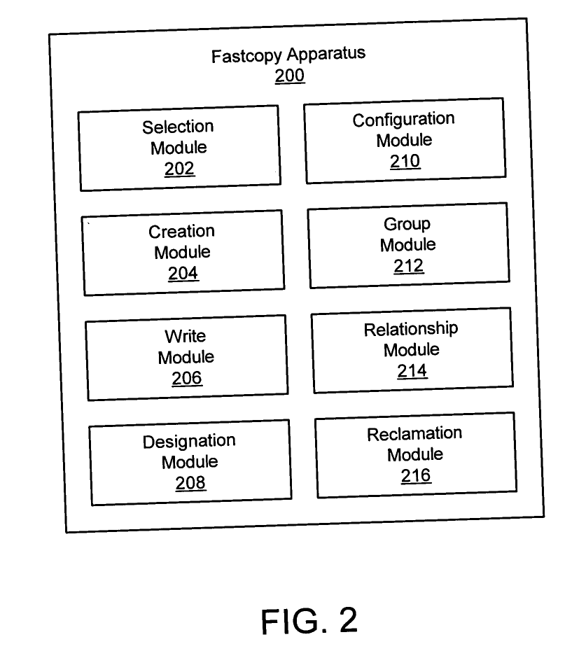

The storage controller 106 also includes a fastcopy apparatus 138 that facilitates the fastcopy operations initiated by the host 102. Alternatively, the fastcopy apparatus 138 may reside on the host 102. In particular, the fastcopy apparatus 138 may use a target storage space 140 to create target virtual volumes 142, 144 that are fastcopy duplicates of the source virtual volumes 132, 134. For example, the fastcopy apparatus 138 may copy the contents of virtual track tables 152, 154 associated with the source volumes 132, 134 to virtual track tables 162, 164 associated with the corresponding target volumes 142, 144. One example of a fastcopy apparatus 138 is shown and described in more detail with reference to FIG. 2. In one embodiment, the target storage space 140 is reserved for creating such target volumes 142, 144.

FIG. 2 depicts one embodiment of a fastcopy apparatus 200 that may be one embodiment of the fastcopy apparatus 138 shown in FIG. 1. The illustrated fastcopy apparatus 200 includes a selection module 202, creation module 204, and a write module 206. The illustrated fastcopy apparatus 200 also includes a designation module 208, a configuration module 210, a group module 212, a relationship module 214, and a reclamation module 216. Other embodiments of the fastcopy apparatus 200 may include fewer or more modules than are shown in FIG. 2.

In one embodiment, the selection module 202 selects a source volume 132 from a source pool. The source pool includes all of the source volumes that are selected for a fastcopy operation. In certain embodiments, the source pool may include a single source volume 132. Alternatively, the source pool may include a plurality of source volumes 132, 134. A particular source volume 132 may be included in the source pool in response to a user selection at the host 102, for example, or based on a designation of the source volume 132 by a backup application (not shown) or other computer program.

In one embodiment, the creation module 204 creates a target volume 142 from the target storage space 140. In another embodiment, the creation module 204 creates the target volume 142 in an autonomic manner, without intervention by a user. In this way, the creation module 204 may create the target volume 142 on demand. For example, the creation module 204 may create the target volume 142 in response to invocation of a fastcopy operation by the host 102. In a further embodiment, the creation module 204 may create a target volume 142 that is identical in size to a corresponding source volume 132, for example.

In other embodiments, the creation module 204 also may generate a source sum that is descriptive of the total size of a source pool. As described above, a source pool includes one or more source volumes 132, 134 that are to be duplicated at the same time or approximately the same time using a fastcopy operation. Therefore, the source sum of the source pool is the summation of the size of all of the source volumes 132, 134 that are identified as belonging to a single fastcopy pool. After generating a source sum, the creation module 204 also may determine if the source sum is greater than the total size of the target storage space 140. Alternatively, the creation module 204 may determine if the target storage space 140 is larger in size than the source sum of the source pool.

In one embodiment, the write module 206 writes the fastcopy data from the source volume 132 to the target volume 142. For example, the write module 206 may write the contents of the volume track table 152 associated with the source volume 132 to the volume track table 162 associated with the corresponding target volume 142.

In one embodiment, the designation module 208 designates the target storage space 140 to be used for creation of the target volumes 142, 144. By having a designated target storage space 140, the chance of accidentally overwriting important production data or other fastcopy target volumes 142, 144 is diminished or eliminated. Additionally, the availability of the designated target storage space 140 allows multiple users to access the target storage space 140 when creating a new target volume 142. In this way, the amount of designated target storage space 140 may be minimized or optimized according to the number of users or the user requirements. Minimization or optimization of the size of the designated target storage space 140 minimizes the amount of wasted space on the storage controller 106.

In one embodiment, the configuration module 210 defines one or more configuration parameters. Furthermore, the configuration module 210 may configure the target storage space 140 to one or more configuration parameters. Some exemplary configuration parameters may include, but are not limited to, a media type parameter, a drive type parameter, a performance parameter, or a cost parameter.

In one embodiment, a media type parameter may designate a type of media, such as magnetic disk or electronic memory, to be used for the target storage space 140. The drive type parameter may designate a type of media drive, such as a hard disk drive (HDD) or tape drive, to be used for the target storage space 140. The performance parameter may designate a performance characteristic or minimum level of performance for the target storage space 140. For example, the performance parameter may specify that high performance Fibre Channel drives operating at 15,000 RPM be used. The cost parameter may designate a cost limitation for the target storage space 140. For example, the cost parameter may specify that low cost SATA (serial advanced technology attachment) drives be used for the target storage space 140.

In one embodiment, the group module 212 creates a fastcopy consistency group. The fastcopy consistency group includes one or more source volumes 132, 134 and a corresponding number of target volumes 142, 144.

In one embodiment, the relationship module 214 creates a fastcopy relationship between a source volume 132 and a corresponding target volume 142. The fastcopy relationship may be used to identify which source volumes 132 and target volumes 142 may be included in a fastcopy consistency group.

In one embodiment, the reclamation module 216 returns a target volume 142 to the target storage space 140 after the target volume 142 has been deleted or is otherwise no longer used by the storage controller 106. When a target volume 142 is in use during or after a flashcopy operation, the target volume 142 may be removed or isolated from the target storage space 140 so that it is not overwritten during a subsequent fastcopy operation. However, once the target volume 142 is no longer in use, the reclamation module 216 returns the capacity of the target volume 142 to the target storage space 140.

For example, when a target volume 142 becomes outdated by a subsequent backup copy of the corresponding source volume 132, the reclamation module 216 responds by including the target volume 142 in the target storage space 140 for future creation of another target volume 144. In this way, the size of the target storage space 140 may be maintained by reusing space that previously belonged to the target storage space 140.

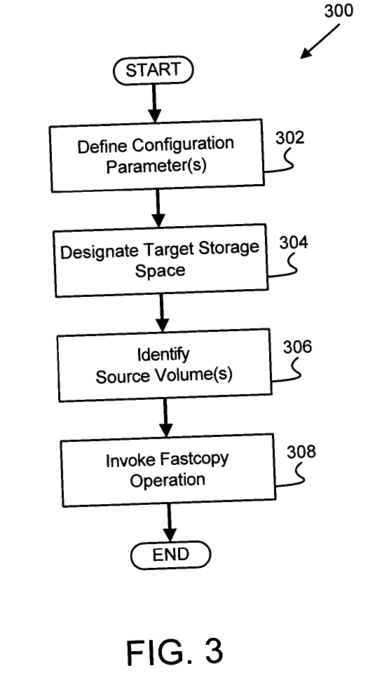

FIG. 3 depicts one embodiment of a user setup method 300 that may be implemented in preparation for a fastcopy operation. The illustrated user setup method 300 begins and a user defines 302 one or more configuration parameters. In one embodiment, the user may employ the configuration module 210 to define 302 the configuration parameters. Alternatively, the configuration module 210 may set the configuration parameters to a default setting.

The designation module 208 then designates 304 the target storage space 140 according to the configuration parameters. In one embodiment, the target storage space 140 is a subset of memory within the storage controller 106. Alternatively, the target storage space 140 may be at least partially located on another type of storage device or on a remote storage device.

After the target storage space 140 has been designated, the user may identify 306 one or more source volumes 132, 134 to be included in the source pool. The user then invokes 308 the fastcopy operation via the host 102 for the selected source volumes 132, 134. The depicted user setup method 300 then ends.

With regard to the identification 306 of the source pool and invocation 308 of the fastcopy operation, a backup application running on the host 102, rather than a user, alternatively may perform the operations described. For example, a backup application on the host 102 may be configured to automatically invoke the fastcopy operation for certain source volumes 132, 134 at predetermined time intervals. In another embodiment, the source volumes 132, 134 may be identified 306 in another manner. Furthermore, the fastcopy operation may be invoked in another manner. In certain embodiments, the user involvement may be minimized, as described above.

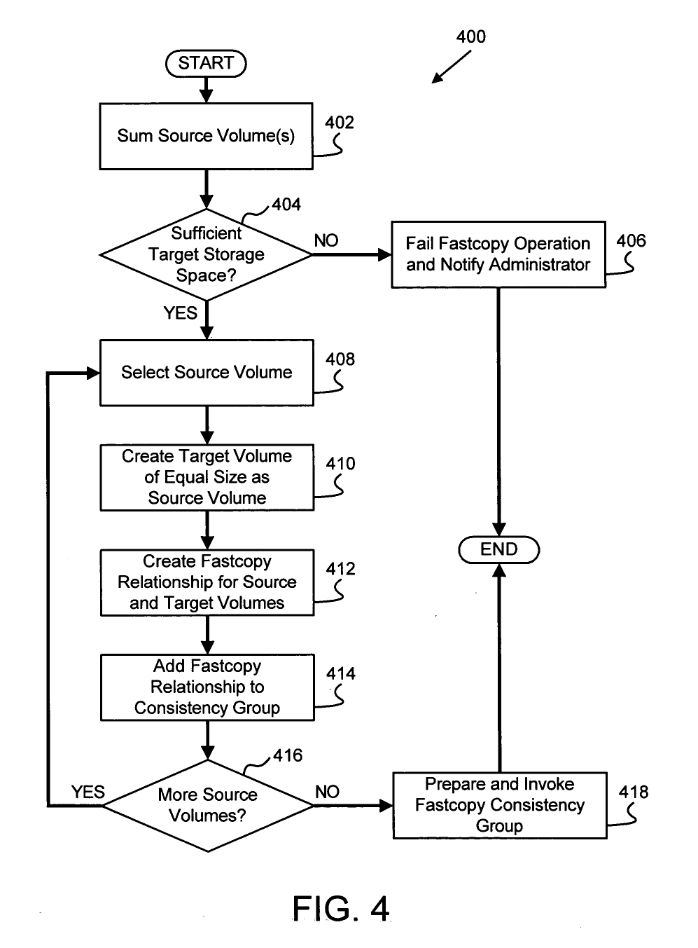

FIG. 4 depicts one embodiment of a fastcopy method 400 that may be implemented in conjunction with the fastcopy apparatus 200 of FIG. 2. The illustrated fastcopy method 400 may begin in response to invocation 308 of a fastcopy operation, as described with reference to FIG. 3.

In response to invocation of the fastcopy operation, the creation module 204 sums 402 the total size of the selected source volumes 132, 134 and determines 404 if the target storage space 140 is sufficient in size to perform the requested fastcopy operation. If the target storage space 140 is too small, then the fastcopy operation fails 406. However, if the target storage space 140 is larger than the sum of the selected source volumes 132, 134, then the group module 212 proceeds to create a consistency group that includes the selected source volumes 132, 134.

In order to create the consistency group for the fastcopy operation, the selection module 202 selects 408 one of the source volumes 132, 134 that is included in the source pool. The creation module 204 then creates 410 a target volume 142 for the selected source volume 132. In one embodiment, the creation module 204 creates 410 a target volume 142 that is equal in size to the corresponding source volume 132. The relationship module 214 subsequently creates 412 a fastcopy relationship for the selected source volume 132 and the corresponding target volume 142. The group module 212 then adds 414 the fastcopy relationship, including the selected source volume 132 and the corresponding target volume 142, to the consistency group for the fastcopy operation.

The selection module 202 then determines 416 if there are additional source volumes 132, 134 for which target volumes 142, 144 have not been created 504. If there are additional source volumes 132, 134, the selection module 202 returns to iteratively select 408 another source volume 132 until all of the source volumes 132, 134 have been included in a fastcopy relationship and added 414 to the consistency group.

After the consistency group is created, the fastcopy apparatus 200 then prepares and invokes 418 the consistency group to create the duplicate copies of the selected source volumes 132, 134. The depicted fastcopy method 400 then ends.

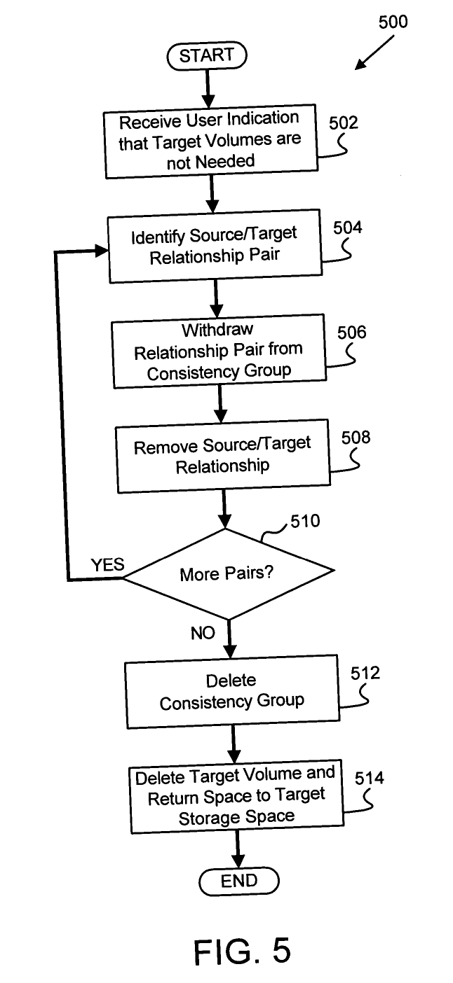

FIG. 5 depicts one embodiment of a reclamation method 500 that may be implemented in conjunction with the reclamation module 216 of the fastcopy apparatus 200 of FIG. 2. In one embodiment, the illustrated reclamation method 500 may be invoked by the reclamation module 216 in response to a determination that a target volume 142 is no longer used by the storage controller 106. For example, when a more recent target volume 142 copy of the corresponding source volume 132 is created, the older target volume 142 copy may be discarded via the depicted reclamation method 500. In another embodiment, the reclamation module 216 may receive 502 an indication from the user that a target volume 142 is no longer needed.

The reclamation module 216 then identifies 504 a source/target relationship pair within the corresponding consistency group and withdraws 506 that source/target relationship pair from the consistency group. The reclamation module 216 also removes 508 the relationship between the source volume 132 and the target volume 142.

After removing 508 a source/target relationship, the reclamation module 216 determines 510 if there are additional relationship pairs in the consistency group. If there are additional relationship pairs, the reclamation module 216 iteratively returns to identify a subsequent relationship pair in the consistency group and proceeds to process all of the relationship pairs.

Once all of the relationship pairs from the consistency group are processed, as described above, the reclamation module 216 deletes 514 the corresponding target volumes 142 and returns 514 the target volume 142 to the target storage space 140. In other words, the reclamation module 216 makes the storage capacity of the target volume 142 available once again to the target storage space 140 so that it potentially may be used to create additional target volumes 142, 144. The depicted reclamation method 500 then ends.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to autonomically create a target volume, the apparatus comprising:
a selection module configured to select a source volume from a source pool;
a creation module coupled to the selection module, the creation module configured to create a target volume from a predefined target storage space, the target volume corresponding to the source volume; and
a write module coupled to the selection module, the write module configured to write fastcopy data from the source volume to the target volume.

2. The apparatus of claim 1, further comprising a designation module coupled to the creation module, the designation module configured to designate the predefined target storage space.

3. The apparatus of claim 1, further comprising a configuration module coupled to the creation module, the configuration module configured to define a configuration parameter for the target storage space.

4. The apparatus of claim 3, wherein the configuration parameter comprises one of a media type parameter, a drive type parameter, a performance parameter, and a cost parameter.

5. The apparatus of claim 1, further comprising a group module coupled to the creation module, the group module configured to create a fastcopy consistency group including the target volume and the source volume.

6. The apparatus of claim 1, further comprising a relationship module coupled to the creation module, the relationship module configured to create a fastcopy relationship between the target volume and the source volume.

7. The apparatus of claim 1, wherein the creation module is further configured to generate a source sum descriptive of a total size of the source pool.

8. The apparatus of claim 7, wherein the creation module is further configured to determine whether the source sum is greater than a total size of the predefined target storage space.

9. The apparatus of claim 1, wherein the creation module is further configured to create the target volume having a volume size that is equal to a size of the source volume.

10. The apparatus of claim 1, further comprising a reclamation module coupled to the creation module, the reclamation module configured to return the target volume to the target storage space in response to a deletion of the target volume.

11. A method for deploying computing infrastructure, comprising integrating computer readable code into a computing system, wherein the code in combination with the computing system is capable of performing the following:
selecting a source volume from a source pool;
creating a target volume from a predefined target storage space, the target volume corresponding to the source volume; and
writing fastcopy data from the source volume to the target volume.

12. The method of claim 11, wherein the code in combination with the computing system is further capable of designating the predefined target storage space in accordance with a configuration parameter.

13. The method of claim 11, wherein the code in combination with the computing system is further capable of returning the target volume to the target storage space in response to a deletion of the target volume.

14. A signal bearing medium tangibly embodying a program of machine-readable instructions executable by a digital processing apparatus to perform operations to create a target volume, the operations comprising:
selecting a source volume from a source pool;
creating a target volume from a predefined target storage space, the target volume corresponding to the source volume; and
writing fastcopy data from the source volume to the target volume.

15. The signal bearing medium of claim 14, wherein the instructions further comprise an operation to designate the predefined target storage space.

16. The signal bearing medium of claim 14, wherein the instructions further comprise an operation to define a configuration parameter for the target storage space, wherein the configuration parameter comprises one of a media type parameter, a drive type parameter, a performance parameter, and a cost parameter.

17. The signal bearing medium of claim 14, wherein the instructions further comprise an operation to create a fastcopy consistency group including the target volume and the source volume.

18. The signal bearing medium of claim 14, wherein the instructions further comprise an operation to create a fastcopy relationship between the target volume and the source volume.

19. The signal bearing medium of claim 14, wherein the instructions further comprise an operation to generate a source sum descriptive of a total size of the source pool and to determine whether the source sum is greater than a total size of the predefined target storage space.

20. The signal bearing medium of claim 14, wherein the instructions further comprise an operation to return the target volume to the target storage space in response to a deletion of the target volume.
